(19) United States
(12) Patent Application Publication
(10) Pub. No.: US 2024/0323227 A1
(43) Pub. Date: Sep. 26, 2024

(54) SYSTEMS AND METHODS FOR BLOCKING SPOOFED COMMUNICATIONS WITH IDENTITY MAPPING TO SAFEGUARD RECIPIENT PRIVACY AND PREVENT FRAUD

(71) Applicant: Capital One Services, LLC, McLean, VA (US)

(72) Inventor: Danial MATEEN, Ruckersville, VA (US)

(73) Assignee: Capital One Services, LLC, McLean, VA (US)

(21) Appl. No.: 18/188,429

(22) Filed: Mar. 22, 2023

(51) Int. Cl. H04L 9/40

(52) U.S. Cl. CPC H04L 63/1483; H04L 63/0407

(57) ABSTRACT

Systems and methods for blocking spoofed communications using hashed identity mappings to safeguard recipient privacy, prevent fraud, and for constant time lookup. The system may receive an incoming communication for a recipient. The system may search the sender identity for a suspicious pattern. The system may hold the incoming communication for further processing. The system may process the sender identity and communication data in a hashed identity mapping to determine an unknown hash, wherein the hashed identity mapping returns an unknown hash, given a sender identity and communication data from the communication. The system may process the unknown hash in an artificial intelligence model. The system may determine a likelihood the incoming communication is a spoofed communication. The system may compare the likelihood against a threshold. The system may display an alert in place of the sender identity. The system may block the incoming communication from reaching the recipient.

### BACKGROUND

A spoofed communication is a communication in which a sender assumes—or “spoofs”—the legitimate identity of an entity who is trusted by the recipient. Billions of dollars are lost each year as a result of spoofed communications. To solve this problem, businesses monitor and process their users' communication devices to discover evidence of such fraud and prevent it from occurring. These methods, however, place users in an even more vulnerable position by exposing users' private data.

In recent years, the use of artificial intelligence-based solutions to solve a variety of problems-including fraud preventions—has exponentially increased. These solutions include, but are not limited to, machine learning, deep learning, etc. (referred to collectively herein as artificial intelligence models, machine learning models, or simply models). Artificial intelligence-based solutions on their own are not enough to solve this problem of user privacy.

### SUMMARY

Methods and systems are described herein for safeguarding recipient privacy and preventing fraud while blocking spoofed communications. In particular, methods and systems are described herein for novel uses and/or improvements to artificial intelligence applications for use in blocking spoofed communications that safeguard recipient privacy. The methods and systems accomplish this by training the artificial intelligence models on identity mappings of users as opposed to training the models directly on users' private data.

In order for systems that block spoofed communications to solve the problem of preventing fraud, they must provide a means for safeguarding the user data that is used to train the system. For example, existing systems can provide unencrypted features of user call data (e.g., time of day, origin, user identity) as direct inputs to teach a model (through feed-forward and back-propagation methods) to estimate a function describing the likelihood of a call being spoofed. However, the difficulty in adapting artificial intelligence models for this practical benefit faces several technical challenges: mainly, the problem that models trained on private user data are, by definition, compromising to those users. User data can be compromised as it is transmitted from the user communication device to the model, if the model is located off-device (e.g., running as a distributed service on the cloud), where it can be intercepted by potential scammers. Other opportunities for potential exposure of private user data can occur if the model itself is accessible (e.g., on the user communication device). By accessing the model and providing it with inputs specific to a certain user (e.g., time zone, payment history, chosen language), the model can be used to train an adversarial model designed to output suggestions for numbers that would not be perceived as spoofed for that user (e.g., bill collection), and thereby enable potential scammers more sophisticated techniques for evading detection.

To overcome these technical deficiencies in adapting artificial intelligence models for this practical benefit, methods and systems disclosed herein provide identity mappings for the purpose of safeguarding recipient privacy and preventing fraud in a system configured to block spoofed communications.

For example, an identity mapping of user data solves the technical problem of user privacy by transforming the data used to train the model. This transformation can be into a different form, which is unrecognizable to a human scammer, but internally consistent enough to enable an artificial intelligence model to output a likelihood of a call being spoofed based upon its input. Accordingly, the methods and systems disclosed block spoofed communications using identity mappings to safeguard recipient privacy and prevent fraud.

In some aspects, the system may receive an incoming communication for a recipient, the incoming communication having a sender identity and communication data. The system may search the sender identity for a suspicious pattern. In response to searching the sender identity for a suspicious pattern, the system may hold the incoming communication for further processing. The system may process the sender identity and communication data in an identity mapping to determine an identity map, wherein the identity mapping returns an identity map given a sender identity and communication data from the communication. The system may process the identity map in an artificial intelligence model, wherein the artificial intelligence model is trained to output a likelihood of an incoming communication being a spoofed communication given an identity map as input. The system may determine a likelihood the incoming communication is a spoofed communication. The system may compare the likelihood against a threshold. In response to comparing the likelihood against the threshold, the system may generate for display, on a user interface, an alert in place of the sender identity. The system may block the incoming communication from reaching the recipient.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for blocking spoofed communications while also safeguarding recipient privacy and preventing fraud, in accordance with one or more embodiments.

FIG. 2 shows an illustrative diagram for a system for processing an identity map in an artificial intelligence model, in accordance with one or more embodiments.

FIG. 3 shows illustrative components for a system used to block spoofed communications, in accordance with one or more embodiments.

FIG. 4 shows a flowchart of the steps involved in blocking spoofed communications, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

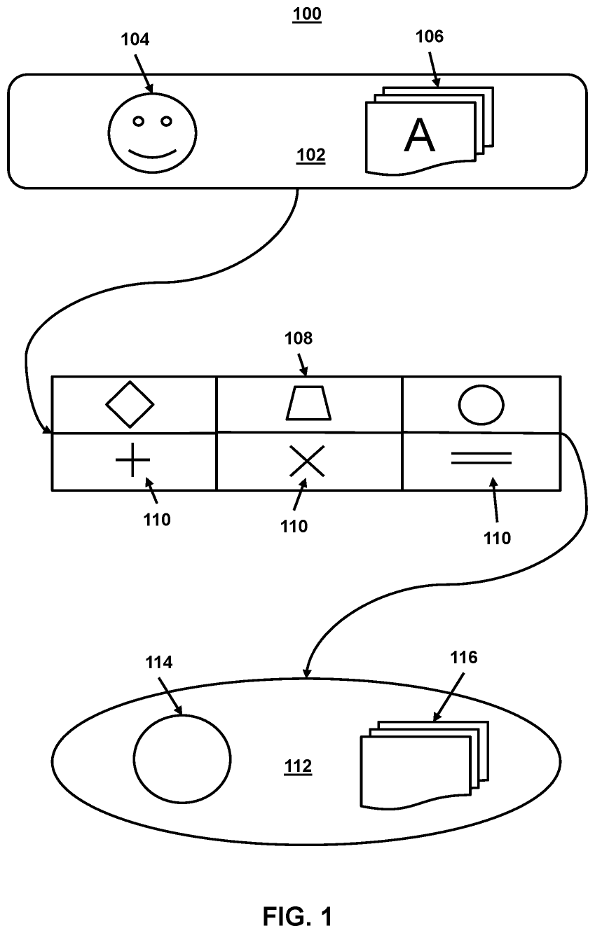

FIG. 1 shows an illustrative diagram for a system 100 for blocking spoofed communications while also safeguarding recipient privacy and preventing fraud, in accordance with one or more embodiments. For example, the system 100 may indicate an identity mapping 108. For example, FIG. 1 illustrates an incoming communication 102, including a sender identity 104 and communication data 106, being processed in the identity mapping 108. The identity mapping 108 determines an identity map 112, which may preserve an essential structure 114 of the sender identity 104 while permuting an order 116 included within the communication data 106. This can enable a model to later learn on the identity map 112 and classify it as spoofed or legitimate, while rendering the incoming communication 102 illegible to a potential scammer. For example, in some embodiments, the identity mapping includes a data structure 110. The data structure 110 may include legitimate identities, each legitimate identity having a current status. In response to looking up the sender identity 104 in the data structure 110, the process can determine an identity map 112 based on the current status, wherein the identity map 112 includes a binary truth value indicating the spoofed status of the incoming communication 102. As such, the system may generate for display, on a user interface, an alert in place of the sender identity, and block the incoming communication 102 from reaching the recipient, while also safeguarding recipient privacy and preventing fraud.

As referred to herein, a “user interface” may comprise a human-computer interaction and communication in a device. For example, a user interface may include display screens, keyboards, a mouse, and/or the appearance of a desktop. For example, a user interface may comprise a way a user interacts with an application or a website.

The system 100 may be used to block spoofed communications. As referred to herein, a “communication” may comprise the imparting or exchanging of information. It may also comprise a means of sending or receiving information. For example, a communication may include a phone call or a video call. In some examples, the communication may comprise an email. In some examples, the communication may comprise a text message. In some examples, the communication may comprise a form of correspondence occurring on a device (e.g., a mobile device, laptop, desktop computer, tablet, wearable, or other object with a user interface) with a sender identity that has been fabricated by a sender so as to assume the identity of a legitimate entity.

As referred to herein, a “sender identity” may comprise a thing that establishes an entity who is responsible for transmitting a communication. For example, a sender identity can include a phone number, a name, or any data identifying a sender, that is, an entity responsible for sending the incoming communication.

As referred to herein, “communication data” may comprise recorded observations regarding a communication, presented in a structured format. It may also comprise facts or ideas represented in a formalized manner and capable of being communicated or manipulated by some process. Additionally, it may comprise digital information. For example, communication data can include time of day, time zone, geographic data, and other metadata associated with the incoming communication.

The system may be used to safeguard user privacy, through the use of identity mappings which rely on a data structure 110. As referred to herein, a “data structure” may include a table in a database. In some embodiments, the data structure may comprise an unstructured list of key-value pairs. In some embodiments, the data structure may comprise a distributed cluster of nodes controlled by a master node and worker nodes, either virtually on the cloud or on edge devices. In some embodiments, the data structure may comprise an array, a linked list, a hash table, a queue, a stack, or a bitmap.

As referred to herein, a “current status” may comprise the condition, position, or standing of an entity in that present moment. It may also comprise an attribute of an application, including a message posted by a user. For example, a current status may include a state from an enumerated list of available user states (e.g., Busy, Active, or Idle). As another example, a current status may include information which can identify whether a sender identity is already in active communication, and, if this is the case, whether this would place the incoming communication at a high likelihood of being spoofed.

As referred to herein, an “alert” may comprise any information intended to give notice of approaching danger. It may also comprise a notification intended to rouse attention. For example, an alarm can include a haptic response (e.g., a mobile device vibration), a sound, a graphical display, or a combination of the foregoing signals, configured for the user interface to which the incoming communication is targeted.

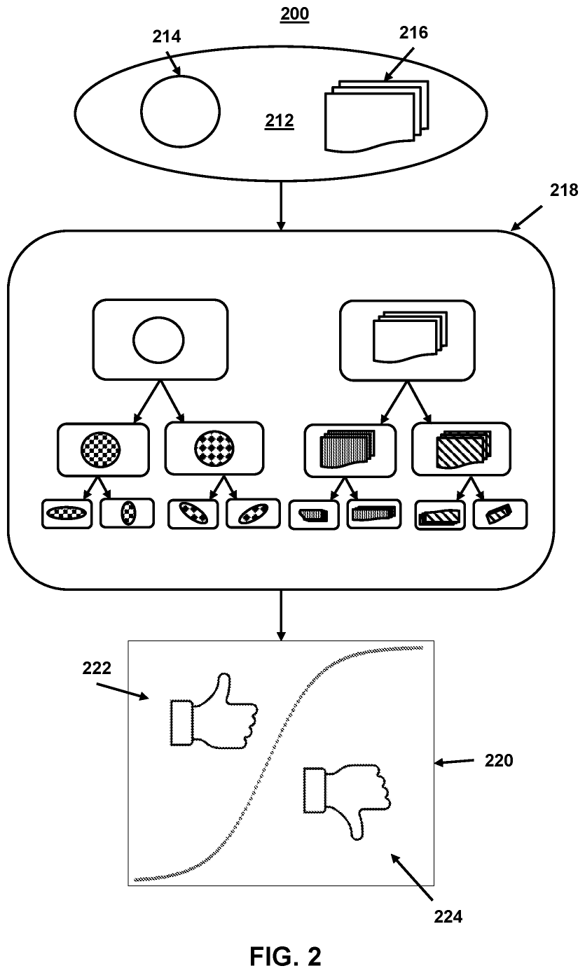

FIG. 2 shows an illustrative diagram for a system 200 for processing an identity map 212 in an artificial intelligence model 218, in accordance with one or more embodiments. The artificial intelligence model 218 is trained to output a likelihood 220 of an incoming communication being a spoofed communication given an identity map 212 as input. For example, given a training dataset of identity maps produced using the system of FIG. 1, in which the identity map 212 has a known spoofed value associated with its transformed communication data 216 and sender identity 214, the artificial intelligence model 218 can learn to make spoofed 222 or non-spoofed 224 classifications based on such data, without compromising user privacy to potential scammers.

The system may use an artificial intelligence model 218. As referred to herein, an “artificial intelligence model” may comprise a real or virtual computer system designed to emulate the brain in its ability to “learn” to assess imprecise data. It may also include the use and development of computer systems that are able to learn and adapt without following explicit instructions, by using algorithms and statistical models to analyze and draw inferences from patterns in data. It may also include an expression, rule, or law that defines a relationship between one variable and another variable. For example, an artificial intelligence model may include an identity function. In some examples, the artificial intelligence model may comprise a statistical distribution. In some examples, the artificial intelligence model may comprise a clustering method. In some examples, the artificial intelligence model may comprise a Neural Network, including an Attention mechanism, a Convolutional layer, an LSTM, or a Transformer, configured in an Adversarial Training architecture, or as part of a Reinforcement Learning policy.

In some embodiments, the system may determine a likelihood of an incoming communication being spoofed by providing an identity map 212 to an artificial intelligence model 218 as input. As referred to herein, a “likelihood” may comprise the state or fact of something's being likely. It may also comprise a subjective assessment of probability, attached to a possible result or to a hypothesis. For example, by determining a likelihood using identity maps, the system may establish a consistent pattern from which to learn an association between a communication being spoofed and the communication data 216 and sender identity 214, without exposing the private data of the recipient and enabling them to be the victim of future potential fraud. Additionally, or alternatively, the system may determine a likelihood by de-identifying communications. For example, the system may determine a likelihood an incoming communication is a spoofed communication by de-identifying the incoming communication to make a de-identified incoming communication, and adding the de-identified incoming communication to the history of de-identified incoming communications to be used as training data for the artificial intelligence model. Additionally, or alternatively, the system may determine a likelihood by using clusters. For example, the system may determine the incoming communication is a spoofed communication by determining clusters from the history of de-identified incoming communications, each cluster having a density based on a number of related communications contained within the cluster. Additionally, or alternatively, the artificial intelligence model may include an order of operations with weights. For example, the artificial intelligence model may include weights, the weights determined by training data. In a practical embodiment, the system can reuse a pre-trained model as a starting point for the artificial intelligence model. By doing so the system may bootstrap the artificial intelligence model's performance, applying insights from a similar problem space, and circumvent the cold-start problem.

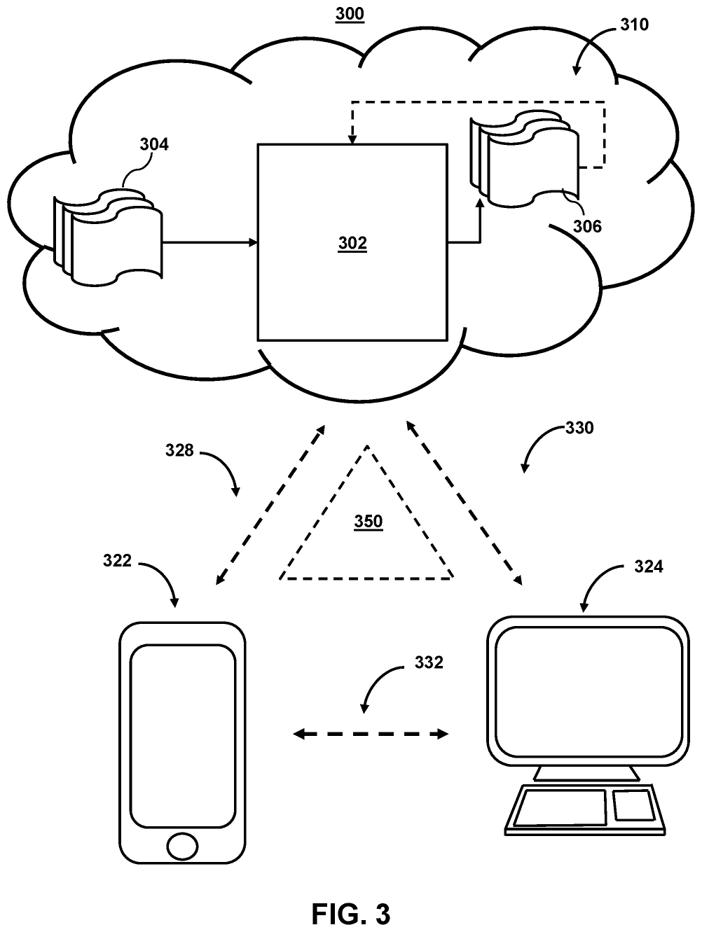

FIG. 3 shows illustrative components for a system used to safeguard recipient privacy, prevent fraud, and enable constant time lookup, in accordance with one or more embodiments. For example, FIG. 3 may show illustrative components for blocking spoofed communications. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include an identity mapping, based on a sender identity and communication data, and also an identity map produced by the identity mapping. To achieve this, cloud components may rely on networking equipment, servers, and data storage. This can include software, containing a hardware abstraction layer that enables the virtualization of resources and helps to drive down costs through economies of scale. A crucial component of the hardware abstraction is dynamic load balancing, in which excess dynamic local workload is distributed evenly across the servers to achieve better service provisioning, resource utilization, and improving the overall performance of the cloud components 310.

Cloud components 310 may include model 302, which may be a machine learning model, artificial intelligence model, etc. (which may be referred to collectively herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., the probability an incoming communication is spoofed).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., “spoofed” or “not spoofed”).

In some embodiments, the model (e.g., model 302) may automatically perform actions based on outputs 306. In some embodiments, the model (e.g., model 302) may not perform any actions. The output of the model (e.g., model 302) may be used to block an incoming communication from reaching a recipient.

System 300 also includes API layer 350. API layer 350 may allow the system to generate summaries across different devices. In some embodiments, API layer 350 may be implemented on a mobile device 322 or user terminal 324. Alternatively, or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols, such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDOS protection, and API layer 350 may use RESTful APIs as standard for external integration.

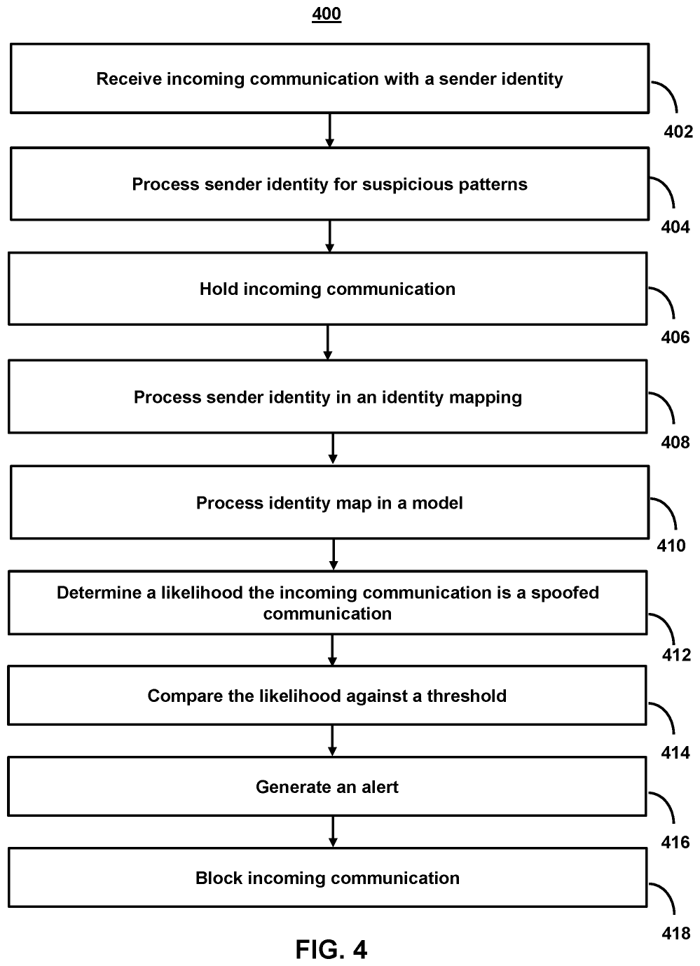

FIG. 4 shows a flowchart of the steps involved in safeguarding recipient privacy and preventing fraud, in accordance with one or more embodiments. For example, the system may use process 400 (e.g., as implemented on one or more system components described above) in order to block spoofed communications.

At step 402, process 400 (e.g., using one or more components described above) receives an incoming communication with a sender identity. For example, the system may receive the incoming communication intended for a recipient, the incoming communication having a sender identity and communication data. In a practical embodiment, receiving the incoming communication can include preventing the recipient from seeing the incoming communication until it has been determined to not be a spoofed communication. By doing so, the system may prevent the recipient from immediately being subject to a spoofed communication and put at risk for fraud.

In some embodiments, the sender identity can include a phone number or an email address. For example, the system may include a phone number with digits, each digit having a position, or an email address with characters, each character having a position. By doing so, the system may enable heuristics to quickly screen calls that merit further processing from calls which should be immediately released to the recipient.

At step 404, process 400 (e.g., using one or more components described above) processes the sender identity for suspicious patterns. For example, the system may search the sender identity for a pattern matching a member belonging to a list of known suspicious numbers. In a practical embodiment, searching the sender identity for a pattern matching a member belonging to a list of known suspicious numbers can include selectively comparing the area code of the sender identity to a listing of apparently legitimate area codes. The same selective comparison can be done with telephone number prefixes. By doing so, the system may quickly and efficiently determine if an incoming call is from a business or government entity, for example, or one of other types of entities a scammer would wish to spoof. In this way, the system can provide a heuristic for quickly screening calls before allowing a recipient to receive them, or before proceeding to more time and resource intensive steps in the process.

In some embodiments, the search may use a string-matching method. For example, the system may process the sender identity and the pattern as arrays of elements belonging to finite sets, in which specific positions in an array are only compared against the same respective position in the other array. In a practical embodiment, this can take the form of creating an index for the digits included in the sender identity and in the pattern, and then building a suffix tree and running a DFS algorithm from the root of the suffix tree. By doing so, the system may determine if a number can be screened in linear time (in which the run-time grows in a one-to-one relationship relative to the number of digits contained within the sender identity).

At step 406, process 400 (e.g., using one or more components described above) holds the incoming communication. For example, the system may, in response to searching the sender identity for a suspicious pattern, hold the incoming communication for further processing. In a practical embodiment, this can include preventing the incoming communication from appearing on a user interface, or otherwise alerting a user to an incoming communication. By doing so, the system may prevent the user from being vulnerable to potential fraud until the incoming communication has been determined to not be spoofed.

In some embodiments, the user interface may generate for display the sender identity along with a warning. For example, the system may generate for display the sender identity along with a warning that the incoming communication may be spoofed and is being processed. In a practical embodiment, while a call is being held, a user may be alerted on their phone that they are potentially receiving a spoofed call, and be shown the identity of that call. By doing so, the system may rely on the user to provide an input to the system, overriding the hold and enabling the incoming call to reach the recipient.

At step 408, process 400 (e.g., using one or more components described above) processes the sender identity in an identity mapping. For example, the system may process the sender identity and communication data in an identity mapping to determine an identity map, wherein the identity mapping returns an identity map given a sender identity and communication data from the communication. In a practical embodiment, the identity mapping may preserve an essential structure of the sender identity and communication data, while permuting an order included within the identity and data. By doing so, the system may enable a model to learn from the information contained within the permuted data, while rendering it illegible to a potential scammer.

In some embodiments, the identity mapping includes a data structure. For example, the system may include a data structure of known spoofed identities, wherein processing the sender identity and communication data in an identity map comprises looking up the sender identity in the data structure and returning an identity map. In a practical embodiment, the identity map can correspond to binary truth value. By doing so, the system may enable more lightweight, less memory-intensive models for determining a likelihood of an incoming communication being spoofed.

In some embodiments, the data structure includes legitimate identities. For example, the data structure may include legitimate identities, each legitimate identity having a current status, and wherein in response to looking up the sender identity in the data structure, determining an identity map based on the current status, wherein the identity map includes a binary truth value indicating the spoofed status of the incoming communication; generating for display, on a user interface, an alert in place of the sender identity; and blocking the incoming communication from reaching the recipient.

At step 410, process 400 (e.g., using one or more components described above) processes the identity map in a model. For example, the system may process the identity map in an artificial intelligence model, wherein the artificial intelligence model is trained to output a likelihood of an incoming communication being a spoofed communication given an identity map as input. In a practical embodiment in which the identity map includes a binary truth value, the artificial intelligence model may include an identity function. By doing so, the system may determine a likelihood the incoming communication is a spoofed communication in constant-time, in which the time it takes to determine is not dependent on the size of the identity map.

In some embodiments, the artificial intelligence model may include an order of operations with weights. For example, the artificial intelligence model may include weights, the weights determined by training data, the training data including a history of de-identified incoming communications, wherein each de-identified incoming communication has features including a sender location, a sender ID, and a time sent, and wherein copying an artificial intelligence model into an identity mapping comprises: creating the identity map based on the order of operations from the artificial intelligence model; and copying the weights from the artificial intelligence model into the identity mapping. In a practical embodiment, the system can reuse a pre-trained model as a starting point for the artificial intelligence model. By doing so the system may bootstrap the artificial intelligence model's performance by applying insights from a similar problem space, and circumvent the cold-start problem.

At step 412, process 400 (e.g., using one or more components described above) determines if the communication is spoofed. For example, the system may determine a likelihood the incoming communication is a spoofed communication. In a practical embodiment, this can include reviewing a history of de-identified incoming communications. By doing so, the system may determine a likelihood based on past activity.

In some embodiments, determining a likelihood can include determining a statistical distribution. For example, the system may determine a likelihood the incoming communication is a spoofed communication by determining a statistical distribution based on the history of de-identified incoming communications, the distribution having a center and a standard deviation; determining a distance between the incoming communication and the center of the distribution; comparing the distance to the standard deviation; and in response to comparing the distance to the standard deviation, determining the likelihood the incoming communication is a spoofed communication. In a practical embodiment, statistical distributions can be directly compared using other metrics. By doing so, the system may be adapted to comparing exponential, Poisson, logarithmic, or other types of distributions.

In some embodiments, determining a likelihood can include clusters. For example, the system may determine the incoming communication is a spoofed communication by determining clusters from the history of de-identified incoming communications, each cluster having a density based on a number of related communications contained with the cluster; determining the cluster for the incoming communication; comparing the density of the cluster for the incoming communication to a threshold density; in response to comparing the density to the threshold density, generating for display, on a user interface, an alert in place of the sender identity; and blocking the incoming communication from reaching the recipient. In a practical embodiment, k-means clustering, DBSCAN, or hierarchical clustering can be used to form the clusters. By doing so, the system may describe alternate domains in which spoofed and non-spoofed communications are more or less closely aligned.

In some embodiments, determining a likelihood can include de-identifying communications. For example, the system may determine a likelihood an incoming communication is a spoofed communication by de-identifying the incoming communication to make a de-identified incoming communication, and adding the de-identified incoming communication to the history of de-identified incoming communications to be used as training data for the artificial intelligence model. In a practical embodiment, de-identifying an incoming communication can include removing direct identifiers, removing specific dates, removing geographic variables, removing variables that pose a risk of being linked to external datasets, and then re-organizing and re-sorting the history of de-identified incoming communications. By doing so, the system may provide an additional layer of security surrounding private user data, and thereby prevent potential fraud.

At step 414, process 400 (e.g., using one or more components described above) compares the likelihood. For example, the system may compare the likelihood against a threshold. In a practical embodiment, the threshold can change in response to new training data provided to the artificial intelligence model. By doing so, the system may adjust to new scamming strategies and provide a more adaptive solution to blocking spoofed communications.

In some embodiments, the threshold can be set according to an evaluation metric as applied to the artificial intelligence model. For example, the system may evaluate the artificial intelligence model according to an evaluation metric, and determine a threshold from the evaluation. In a practical embodiment, an artificial intelligence model may be evaluated according to accuracy, wherein the model outputs a likelihood of a call being spoofed, the call being taken from a dataset of calls with a known spoofed value. The likelihood at which the model is able to predict calls with an acceptable accuracy can become the threshold likelihood for the model. By doing so, the system may check its own performance against a gold-standard dataset.

At step 416, process 400 (e.g., using one or more components described above) generates an alert. For example, the system may, in response to comparing the likelihood against the threshold, generate for display, on a user interface, an alert in place of the sender identity. In a practical embodiment, the alert may inform a recipient that a spoof call has been blocked from reaching the recipient, and provide the phone number of the spoofed call, as well as a link to a website to report the spoofed call. By doing so, the system may provide greater transparency for a recipient.

In some embodiments, process 400 generates a warning. For example, the system may, in response to comparing the likelihood against the threshold, generate for display, on a user interface, the sender identity along with a warning, the warning including the likelihood the incoming communication is spoofed. In a practical embodiment, the warning could inform a recipient of the model's accuracy when making such determinations. By doing so, the system may inform a recipient of a call being potentially spoofed.

At step 418, process 400 (e.g., using one or more components described above) blocks the communication. For example, the system may block the incoming communication from reaching the recipient. In a practical embodiment, at this step, the system would prevent a call from reaching a recipient, being logged in a call archive, or being registered by any endpoint device associated with the recipient. By doing so, the system may lower the risk of a recipient receiving a fraudulent communication.

In some embodiments, the process can relinquish the incoming communication to the recipient. For example, the system may generate for display, on a user interface, the sender identity along with a warning, including the likelihood the incoming communication is spoofed, and relinquish the incoming communication to the recipient. By doing so, the system may inform a recipient of a call being potentially spoofed, while still providing the recipient with the option of taking the call.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving the incoming communication for a recipient, the function that outputs a constant incoming communication having a sender identity and communication data; searching the sender identity for a suspicious pattern, wherein the suspicious pattern includes characters organized by index; in response to searching the sender identity for a suspicious pattern, holding the incoming communication from reaching the recipient to allow further processing of the incoming communication; processing the sender identity and communication data in the hashed identity mapping to determine an unknown hash; processing the unknown hash in the artificial intelligence model; determining a likelihood the incoming communication is a spoofed communication; comparing the likelihood against a threshold, wherein the threshold includes an evaluation metric based on the artificial intelligence model; in response to comparing the likelihood against the threshold, generating for display, on a user interface, an alert in place of the sender identity; and blocking the incoming communication from reaching the recipient.
2. A method, the method comprising: receiving an incoming communication for a recipient, the incoming communication having a sender identity and communication data; searching the sender identity for a suspicious pattern; in response to searching the sender identity for a suspicious pattern, holding the incoming communication for further processing; processing the sender identity and communication data in a hashed identity mapping to determine an unknown hash, wherein the hashed identity mapping returns an unknown hash given a sender identity and communication data from the communication; processing the unknown hash in an artificial intelligence model, wherein the artificial intelligence model is trained to output a likelihood of an incoming communication being a spoofed communication given an unknown hash as input; determining a likelihood the incoming communication is a spoofed communication; comparing the likelihood against a threshold; in response to comparing the likelihood against the threshold, generating for display, on a user interface, an alert in place of the sender identity; and blocking the incoming communication from reaching the recipient.
3. The method of any one of the preceding embodiments, wherein comparing the likelihood against a threshold comprises: in response to comparing the likelihood against the threshold, generating for display, on a user interface, the sender identity; and relinquishing the incoming communication to the recipient.
4. The method of any one of the preceding embodiments, wherein the method further comprises determining the threshold based on an evaluation metric.
5. The method of any one of the preceding embodiments, wherein determining the threshold further comprises applying an evaluation metric to the artificial intelligence model; determining a desired score for the artificial intelligence model based on the evaluation metric; and setting the threshold to achieve the desired score.
6. The method of any one of the preceding embodiments, wherein determining a likelihood the incoming communication is a spoofed communication comprises generating for display, on a user interface, the sender identity along with a warning including the likelihood the incoming communication is spoofed; and relinquishing the incoming communication to the recipient.
7. The method of any one of the preceding embodiments, wherein the sender identity includes a phone number with digits, each digit having a position, and wherein searching the sender identity for a suspicious pattern comprises comparing a subset of the digits from the phone number against a list of suspicious digits, respective of position; and in response to comparing the subset of digits against the list of suspicious digits, holding the incoming communication for further processing.
8. The method of any one of the preceding embodiments, wherein the identity mapping includes a data structure of known spoofed identities, and wherein processing the sender identity and communication data in an identity map comprises looking up the sender identity in the data structure; and returning an identity map.
9. The method of any one of the preceding embodiments, wherein the data structure also includes identities, each identity having a current status, and wherein processing the sender identity and communication data in an identity map comprises: in response to looking up the sender identity in the data structure, determining an identity map based on the current status, wherein the identity map includes a binary truth value indicating the spoofed status of the incoming communication; generating for display, on a user interface, an alert in place of the sender identity; and blocking the incoming communication from reaching the recipient.
10. The method of any one of the preceding embodiments, wherein the current status includes a binary truth value indicating the spoofed status of the incoming communication.
11. The method of any one of the preceding embodiments, wherein the artificial intelligence model has weights, the weights determined by training data, the training data including a history of de-identified incoming communications, wherein each de-identified incoming communication has features including a sender location, a sender ID, and a time sent, and wherein copying an artificial intelligence model into an identity map comprises creating the identity map based on the order of operations from the artificial intelligence model; and copying the weights from the artificial intelligence model into the identity map.
12. The method of any one of the preceding embodiments, wherein determining a likelihood the incoming communication is a spoofed communication comprises determining a statistical distribution based on the history of de-identified incoming communications, the distribution having a center and a standard deviation; determining a distance between the incoming communication and the center of the distribution; comparing the distance to the standard deviation; and in response to comparing the distance to the standard deviation, determining the likelihood the incoming communication is a spoofed communication.
13. The method of any one of the preceding embodiments, wherein determining a likelihood the incoming communication is a spoofed communication comprises determining clusters from the history of de-identified incoming communications, each cluster having a density based on a number of related communications contained with the cluster; determining the cluster for the incoming communication; comparing the density of the cluster for the incoming communication to a threshold density; in response to comparing the density to the threshold density, generating for display, on a user interface, an alert in place of the sender identity; and blocking the incoming communication from reaching the recipient.
14. The method of any one of the preceding embodiments, wherein the method further comprises de-identifying the incoming communication to make a de-identified incoming communication; and adding the de-identified incoming communication to the history of de-identified incoming communications to be used as training data for the artificial intelligence model.
15. A tangible, non-transitory, machine-readable medium storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for blocking spoofed communications to safeguard recipient privacy, prevent fraud, and enable constant time lookup, the system comprising:
cloud-based storage circuitry configured to store:
a hashed identity mapping, wherein the hashed identity mapping returns unknown hashes given sender identities and communication data from incoming communications, and
an artificial intelligence model, wherein the artificial intelligence model is trained to output likelihoods of incoming communications being spoofed communications given unknown hashes as input;
cloud-based control circuitry configured to:
receive an incoming communication intended for a recipient, the incoming communication having a sender identity and communication data,
search the sender identity for a suspicious pattern, wherein the suspicious pattern includes characters organized by index,
in response to searching the sender identity for the suspicious pattern, hold the incoming communication from reaching the recipient to allow further processing of the incoming communication,
process the sender identity and communication data in the hashed identity mapping to determine an unknown hash,
process the unknown hash in the artificial intelligence model,
determine that the incoming communication is spoofed based on comparing a likelihood against a threshold, wherein the threshold includes an evaluation metric based on the artificial intelligence model; and
cloud-based input/output circuitry configured to:
in response to comparing the likelihood against the threshold, generate for display, on a user interface, an alert in place of the sender identity, and
block the incoming communication from reaching the recipient.

2. A method for blocking spoofed communications to safeguard recipient privacy and prevent fraud, the method comprising:
receiving an incoming communication for a recipient, the incoming communication having a sender identity and communication data;
searching the sender identity for a suspicious pattern;
processing the sender identity and communication data in an identity mapping to determine an identity map, wherein the identity mapping returns the identity map given the sender identity and communication data;
processing the identity map in an artificial intelligence model, wherein the artificial intelligence model is trained to output a likelihood of the incoming communication being spoofed given the identity map as input, and wherein processing the identity map is dependent on the search for the suspicious pattern;
determining that the incoming communication is a spoofed communication based on comparing the likelihood of the incoming communications being spoofed against a threshold;
in response to comparing the likelihood against the threshold, generating for display, on a user interface, an alert in place of the sender identity; and
blocking the incoming communication from reaching the recipient.

3. The method from claim 2, wherein comparing the likelihood against the threshold comprises:
in response to comparing the likelihood against the threshold, generating for display, on the user interface, the sender identity; and
relinquishing the incoming communication to the recipient.

4. The method from claim 2, wherein the method further comprises determining the threshold based on an evaluation metric.

5. The method from claim 4, wherein determining the threshold further comprises:
applying the evaluation metric to the artificial intelligence model;
determining a desired score for the artificial intelligence model based on the evaluation metric; and
setting the threshold to achieve the desired score.

6. The method from claim 2, wherein determining the likelihood the incoming communication is the spoofed communication comprises:
generating for display, on the user interface, the sender identity along with a warning including the likelihood the incoming communication is spoofed; and
relinquishing the incoming communication to the recipient.

7. The method from claim 2, wherein the sender identity includes a phone number with digits, each digit having a position, and wherein searching the sender identity for the suspicious pattern comprises:
comparing a subset of the digits from the phone number against a list of suspicious digits, respective of the position; and
in response to comparing the subset of the digits against the list of suspicious digits, holding the incoming communication for further processing.

8. The method from claim 2, wherein the identity mapping includes a data structure of known spoofed identities, and wherein processing the sender identity and communication data in the identity map comprises:
looking up the sender identity in the data structure; and
returning the identity map.

9. The method from claim 8, wherein the data structure also includes identities, each identity having a current status, and wherein processing the sender identity and communication data in the identity map comprises:
in response to looking up the sender identity in the data structure, determining the identity map based on the current status, wherein the identity map includes a binary truth value indicating a spoofed status of the incoming communication;
generating for display, on the user interface, the alert in place of the sender identity; and
blocking the incoming communication from reaching the recipient.

10. The method from claim 9, wherein the current status includes the binary truth value indicating the spoofed status of the incoming communication.

11. The method from claim 2, wherein the artificial intelligence model has weights, the weights determined by training data, the training data including a history of de-identified incoming communications, wherein each de-identified incoming communication has features including a sender location, a sender ID, and a time sent, and wherein copying the artificial intelligence model into the identity map comprises:
creating the identity map based on an order of operations from the artificial intelligence model; and
copying the weights from the artificial intelligence model into the identity map.

12. The method from claim 11, wherein determining the likelihood the incoming communication is the spoofed communication comprises:
determining a statistical distribution based on the history of the de-identified incoming communications, the distribution having a center and a standard deviation;
determining a distance between the incoming communication and the center of the distribution;
comparing the distance to the standard deviation; and
in response to comparing the distance to the standard deviation, determining the likelihood the incoming communication is the spoofed communication.

13. The method from claim 11, wherein determining the likelihood the incoming communication is the spoofed communication comprises:
determining at least one cluster from the history of the de-identified incoming communications;
determining a cluster from the at least one cluster for the incoming communication, the cluster having a density based on a number of related communications contained with the cluster;
comparing the density of the cluster for the incoming communication to a threshold density;
in response to comparing the density to the threshold density, generating for display, on the user interface, the alert in place of the sender identity; and
blocking the incoming communication from reaching the recipient.

14. The method from claim 11, wherein the method further comprises:
de-identifying the incoming communication to make a de-identified incoming communication; and
adding the de-identified incoming communication to the history of the de-identified incoming communications to be used as training data for the artificial intelligence model.

15. A non-transitory, computer-readable medium, comprising instructions that, when executed by one or more processors, cause operations comprising:
receiving a communication for a recipient, the communication having an identity and data;
searching the identity for a pattern;
processing the identity and data in an identity mapping to determine an identity map, wherein the identity mapping returns identity maps given identities and data from communications;
processing the identity map in an artificial intelligence model, wherein the artificial intelligence model is trained to output likelihoods of communications being spoofed given unknown hashes as input;
determining a likelihood that the communication is spoofed;
comparing the likelihood against a threshold;
in response to comparing the likelihood against the threshold, generating for display, on a user interface, an alert in place of the identity; and
blocking the communication from reaching the recipient.

16. The non-transitory, computer-readable medium of claim 15, wherein determining the likelihood that the communication is spoofed comprises:
generating for display, on the user interface, the identity along with a warning including the likelihood the communication is spoofed; and
relinquishing the communication to the recipient.

17. The non-transitory, computer-readable medium of claim 15, wherein the identity includes a phone number with digits, each digit having a position, and wherein determining the communication is a potentially spoofed communication based on the identity comprises:
comparing a subset of digits from the phone number against a list of suspicious digits, respective of position; and
in response to comparing the subset of digits against the list of suspicious digits, copying the artificial intelligence model into the identity map.

18. The non-transitory, computer-readable medium of claim 15, wherein the artificial intelligence model includes a data structure of known spoofed identities, and wherein determining the likelihood the communication is spoofed comprises:
looking up the identity in the data structure;
in response to looking up the identity in the data structure, generating for display, on the user interface, the alert in place of the identity; and
blocking the communication from reaching the recipient.

19. The non-transitory, computer-readable medium of claim 18, wherein the data structure also includes legitimate identities, each legitimate identity having a current status, and wherein comparing the likelihood against the threshold comprises:
in response to looking up the identity in the data structure, determining the likelihood the communication is spoofed based on the current status;
generating for display, on the user interface, the alert in place of the identity; and
blocking the communication from reaching the recipient.

20. The non-transitory, computer-readable medium of claim 18, wherein the artificial intelligence model has an order of operations with weights, the weights determined by training data, the training data including a history of de-identified incoming communications, wherein each de-identified incoming communication has features including a sender location, a sender ID, and a time sent, and wherein copying the artificial intelligence model into the identity map comprises:
creating the identity map based on the order of operations from the artificial intelligence model; and
copying the weights from the artificial intelligence model into the identity map.
